(19) United States
(12) Patent Application Publication
(10) Pub. No.: US 2012/0098182 A1
(43) Pub. Date: Apr. 26, 2012

(54) QUICK RELEASE STRUCTURE OF WOODWORKING CLAMP

(76) Inventor: Ching-Chen Yang, Taichung City (TW)

(21) Appl. No.: 12/907,995

(22) Filed: Oct. 20, 2010

(51) Int. Cl. B25B 5/16

(52) U.S. Cl. 269/208

(57) ABSTRACT

A quick release structure of a woodworking clamp includes a clamp body, a transverse rod and a fixed chuck. The clamp body has a movable chuck and a trigger for activating the sliding of the clamp body along the transverse rod. A fixing rod passes through a fixing hole to thereby fix the fixed chuck to the transverse rod. One end of the fixing rod has two positioning portions. The fixed chuck has an accommodating portion. Both sides of the accommodating portion have a pivoting member respectively for pivotally connecting to a quick release element. The outer surface of the quick release element has a pressing portion having elongate holes on its two opposite side walls for allowing the positioning portions of the fixing rod to be engaged therein. By this structure, the fixed chuck can be detached from or assembled with the movable chuck easily.

### BACKGROUND OF THE INVENTION

1. Field of the Invention

The present invention relates to a woodworking clamp, and in particular to a quick release structure for a woodworking clamp.

2. Description of the Prior Art

When several plate-like workpieces such as wood plates, metallic plates, plastic plates or the like are to be bound together or machined at the same time, a large-sized portable clamp is used for clamping these plates together because a stationary clamp (such as a vise) fixed on a work bench cannot be moved to meet the positions of the plates. A common portable clamp has a transverse positioning rod on which a clamp body and a chuck are provided. By adjusting the position of the clamp body relative to the chuck, the portable clamp can be used to clamp several plates.

Traditionally, the clamp fixes a workpiece onto the work bench in two ways. One way is to sandwich the workpiece between a fixed end and a movable end of the clamp, in which the movable end moves along a guiding rod toward the fixed end to sandwich the workpiece therebetween. The other way is to support the workpiece having an inner hole, in which the fixed end and the movable end of the clamp are disposed into the inner hole, and then the movable end moves along a guiding rod away from the fixed end to thereby hold the workpiece. As shown in FIG. 10, the guiding rod (10) is basically provided with two positioning holes (3a) and (3b). The fixed end (1) is provided with a fixing hole (1a) and a guiding trough (1b). The guiding rod (3) is inserted into the guiding trough (1b) of the fixed end (1), and then the fixing hole (1a) of the fixed end (1) is aligned with one positioning hole (3a) or (3b) of the guiding rod (3). Then, a nut (5) is threadedly connected to one side of the fixing hole (1a) of the fixed end (1). A bolt (6) having threads (6a) passes through the fixing hole (1a) of the fixed end (1) and the positioning holes (3a, 3b) of the guiding rod (3). With the threaded engagement between the bolt (6) and the nut (5), the fixed end (1) can be fixed onto the guiding rod (3). However, in such a structure, the bolt (6) has to be detached from the nut (5) every time the fixed end (1) is to be adjusted, which is very inconvenient for the user.

In view of the above, the present inventor proposes a novel structure based on his expert experience and research.

### SUMMARY OF THE INVENTION

The primary object of the present invention is to provide a quick release structure for a woodworking clamp, which can be assembled or detached easily and quickly when the clamping position of a chuck on the woodworking clamp is to be changed. Thus, the operating efficiency and convenience of the present invention are both improved.

In order to achieve the above object, embodiments of the present invention provide a quick release structure for a woodworking clamp, which includes a clamp body, a transverse rod and a fixing chuck. The upper edge of the clamp body is provided with a movable chuck. The clamp body is slidingly connected on one end of the transverse rod. The fixed chuck has a fixing rod disposed through a fixing hole of the transverse rod, thereby fixing the fixed rod to the other end of the transverse rod. One end of the fixing rod is provided with two positioning portions. The positioning portions may be integrally formed with the fixing rod. Alternatively, the outer end of the fixing rod is connected to a connecting block, and both sides of the top surface of the connecting block are provided with a positioning portion, respectively. An accommodating portion is formed in one side of the fixed chuck which the transverse rod is disposed through. Both sides of an upper portion of the accommodating portions are provided with a positioning hole respectively, and a shaft hole is formed below each positioning hole. Both sides of the upper portion of the quick release element are provided with a positioning protrusion respectively, and a positioning shaft is provided below the positioning protrusion. With the two positioning shafts being disposed into the shaft holes and the two positioning protrusions being engaged in the positioning holes, the quick release structure can be pivotally connected in the accommodating portion to swing in a range of angles. The outer surface of the quick release structure is provided with a pressing portion. Two opposite inner walls of the quick release structure are formed with an elongate pivotal hole respectively for allowing the positioning portions of the fixing rod to be pivotally connected thereto. Thus, when the quick release structure is pivotally connected into the accommodating portion of the fixed chuck, the fixing rod can be connected into or removed from the fixing hole by simply pressing the pressing portion. In this way, the fixed chuck can be detached or assembled quickly. The swinging of the quick release structure drives the fixing rod to move horizontally to separate from or pass through the fixing hole, thereby detaching or assembling the fixed chuck. Therefore, the efficiency and quality of the present invention are both improved greatly.

The above objects and structural and functional features of the present invention will be described in more detail with reference to a preferred embodiment thereof shown in the accompanying drawings

### BRIEF DESCRIPTION OF THE DRAWINGS

FIG. 1 is an exploded perspective view of an embodiment of the present invention;

FIG. 2 is another exploded perspective view of an embodiment of the present invention;

FIG. 3 is a cross-sectional view showing an embodiment of the present invention in a detached state;

FIG. 4 is a cross-sectional view showing an embodiment of the present invention in a fixed state;

FIG. 5 is a schematic view showing the state before a fixing rod is removed from a fixing hole;

FIG. 6 is a schematic view showing the state of a fixing rod being removed from a fixing hole;

FIG. 7 is a schematic view showing the state after a fixing rod is removed from a fixing hole;

FIG. 8 is a schematic view showing a first operating mode of an embodiment of the present invention for clamping an article;

FIG. 9 is a schematic view showing a second operating mode of an embodiment of the present invention for clamping an article; and

FIG. 10 is a cross-sectional view of a conventional woodworking clamp.

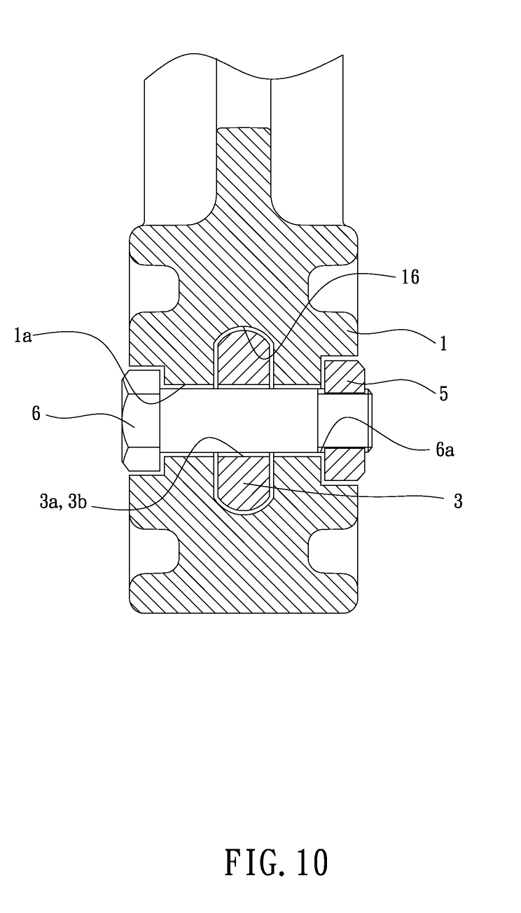

### DETAILED DESCRIPTION OF THE INVENTION

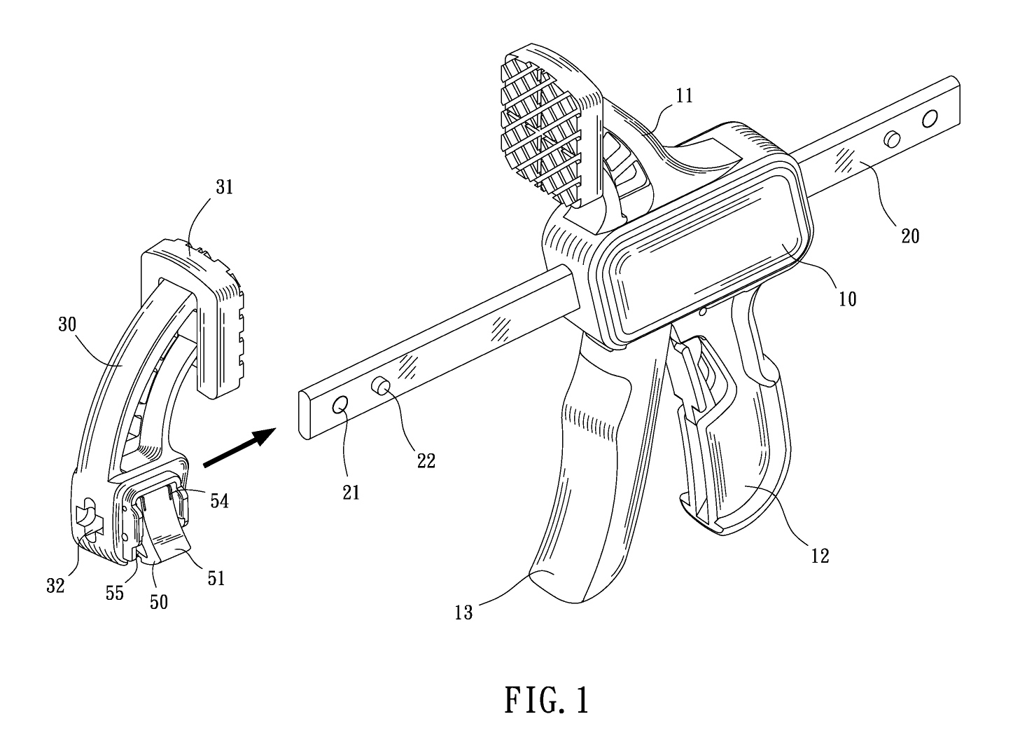

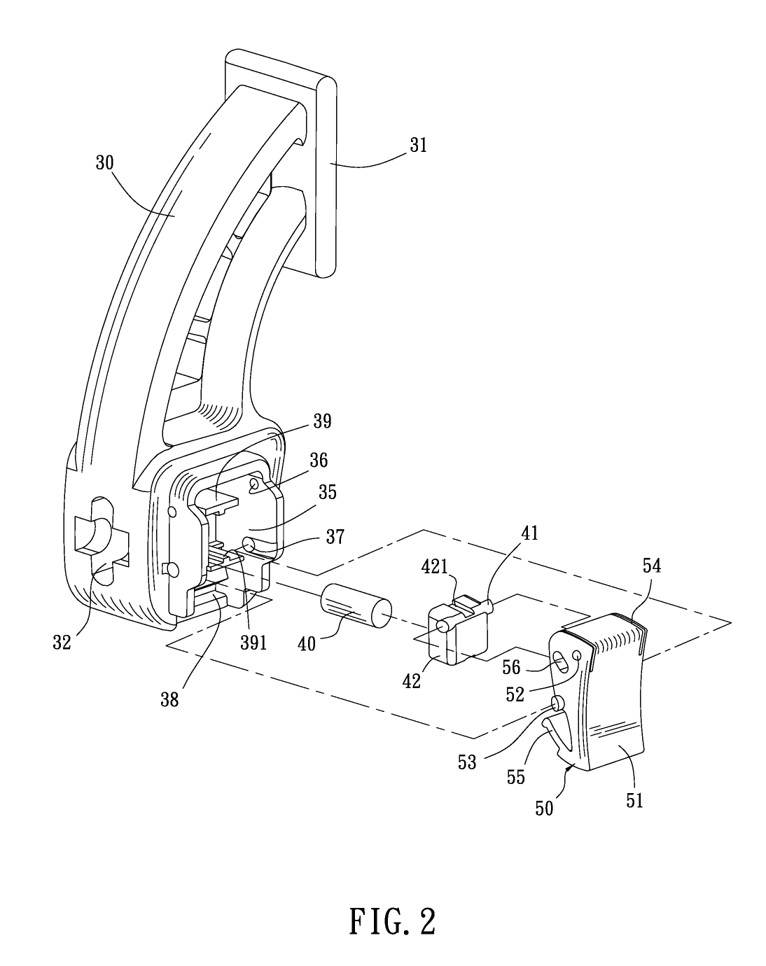

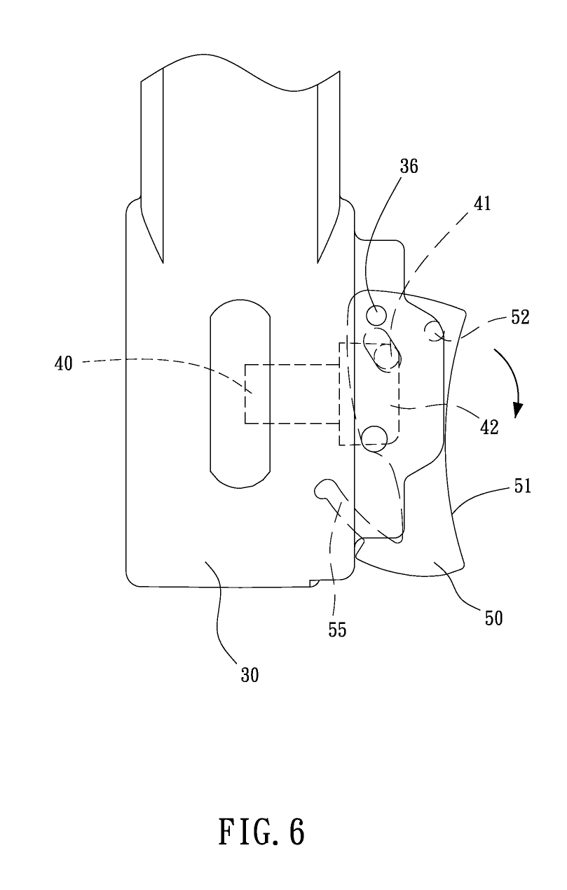

Please refer to FIGS. 1 to 9. Embodiments of the present invention provide a quick release structure for a woodworking clamp, which includes a clamp body (10), a transverse rod (20), a fixed chuck (30), a fixing rod (40), and a quick release element (50). The fixing rod (40) and a quick release element (50) are used for securing the fixed chuck (30) to the transverse rod (20).

The clamp body (10) is R-shaped and has an inner hollow portion through which the transverse rod (20) is disposed. An engaging member (not shown) is provided on the clamp body (10). A movable chuck (11) protrudes from the upper surface of the clamp body (10). A grip (12) and a trigger (13) are provided on the lower surface the clamp body (10). The trigger (13) drives the engaging member to engage with or disengage from the transverse rod (20), so that the movable chuck (11) of the clamp body (10) can slide on the transverse rod (20). The movable chuck (11) is conventional and thus the description thereof is omitted.

The transverse rod (20) is an elongate plate for allowing the clamp body (10) to slide thereon. Both ends of the transverse rod (20) are provided near its edge with a fixing hole (21) and a restricting portion (22) respectively. The restricting portion (22) is configured to allow the fixed chuck (30) to be fixed to a desired position. Then, the fixing rod (40) is disposed through the fixing hole (21) to thereby fix the fixed chuck (30).

A clamping portion (31) is provided in the upper portion of the fixed chuck (30). A cross-like through-hole (32) is provided in a lower portion of the fixed chuck (30). The radial inner edge of the fixed chuck (30) is provided with an engaging hole (34) perpendicular to the through-hole (32). The fixing rod (40) is sequentially disposed through the engaging hole (34) and the fixing hole (21), thereby connecting the fixed chuck (30) to the transverse rod (20). One side of the fixed chuck (3) opposite the engaging hole (34) is formed with an accommodating portion (35). Both sides of the upper portion of the accommodating portion (35) are provided with a positioning hole (36) respectively. Both sides of the lower portion of the accommodating portion (35) are provided with a shaft hole (37) respectively for allowing the quick release element (50) to be pivotally connected thereto. The inner surface of the accommodating portion (35) is provided with an engaging trough (38) below the engaging hole (34). The engaging trough (38) is configured to allow one side of the quick release element (50) to be inserted therein.

The fixing rod (40) is provided with two positioning portions (41) facing each other at one end adjacent to the quick release element (50). The two positioning portions (41) may be integrally formed with the fixing rod (40). Alternatively, in the present embodiment, the two positioning portions (41) may be assembled with the fixing rod (40). That is, the fixing rod (40) is made of metallic materials. One end of the fixing rod (40) is connected to a connecting block (42) made of plastic materials. The two positioning portions (41) are provided on both sides of the top end of the connecting block (42). The upper surface and the lower surface of the connecting block (42) are provided with a trough (421) respectively. The fixing chuck (30) is provided with two partitioning plates (39) in the accommodating portion (35) to correspond to the engaging hole (34). Two facing surfaces of the portioning plates (39) are provided with a rib (391) respectively for insertion into the trough (421) when the connecting block (42) is disposed on the portioning plate (39).

The quick release element (50) is provided on its outer surface with a curved pressing portion (51). Two opposite outer surfaces of the quick release element (50) are provided with a positioning protrusion (52) respectively. A positioning shaft (53) is provided below the positioning protrusion (52). Two opposite inner walls of the quick release element (50) are provided with an elongate pivotal hole (56) respectively. The positioning portions (41) of the fixing rod (40) are pivotally engaged within the pivotal holes (56) respectively to be drivingly connected with the quick release element (50). With the two positioning shafts (53) disposed into the two shaft holes (37) of the fixed chuck (30), the quick release element (50) is pivotally connected into the accommodating portion (35) of the fixed chuck (30). Both sides of the quick release element (50) are respectively provided near its edge with a slot (54) of suitable length. With this structure, both side surfaces of the quick release element (50) can be elastically pressed to facilitate the assembly of the two positioning shafts (53) within the corresponding shaft holes (37).

The two positioning protrusions (52) are engaged within the positioning holes (36) respectively. The quick release element (50) is provided with a curved elastic piece (55) below the two pivotal holes (56). The elastic piece (55) is inserted into the engaging trough (38) of the fixed chuck (30) when the quick release element (50) is pressed.

With the above structure, a user presses the quick release element (50) to swing, thereby causing the fixing rod (40) to horizontally remove from or pass through the fixing hole (21). In this way, the fixed chuck (30) can be assembled or disassembled quickly.

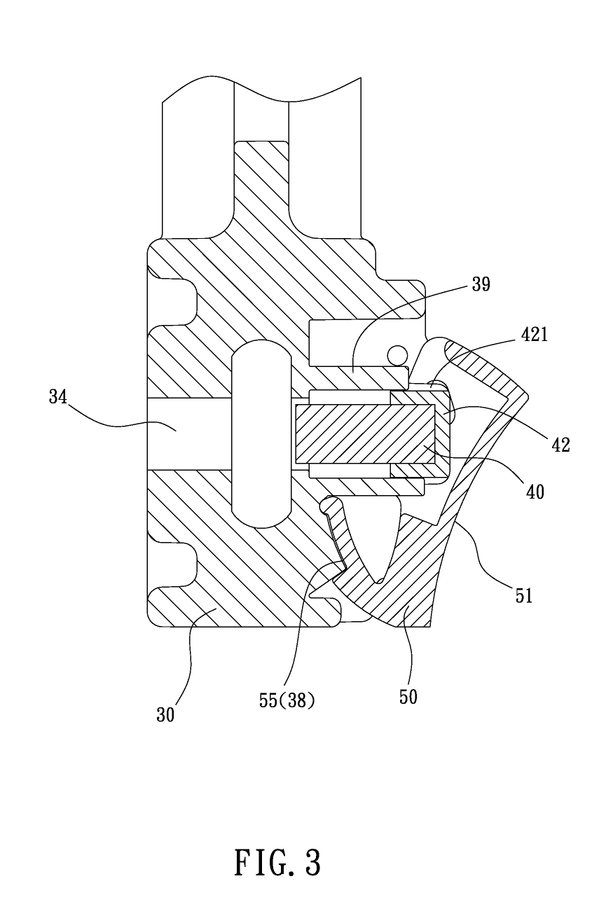

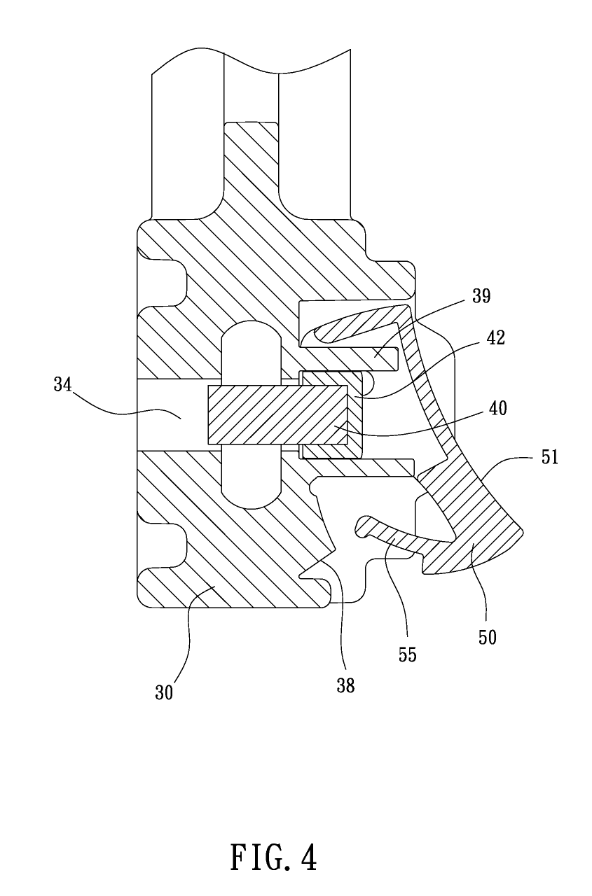

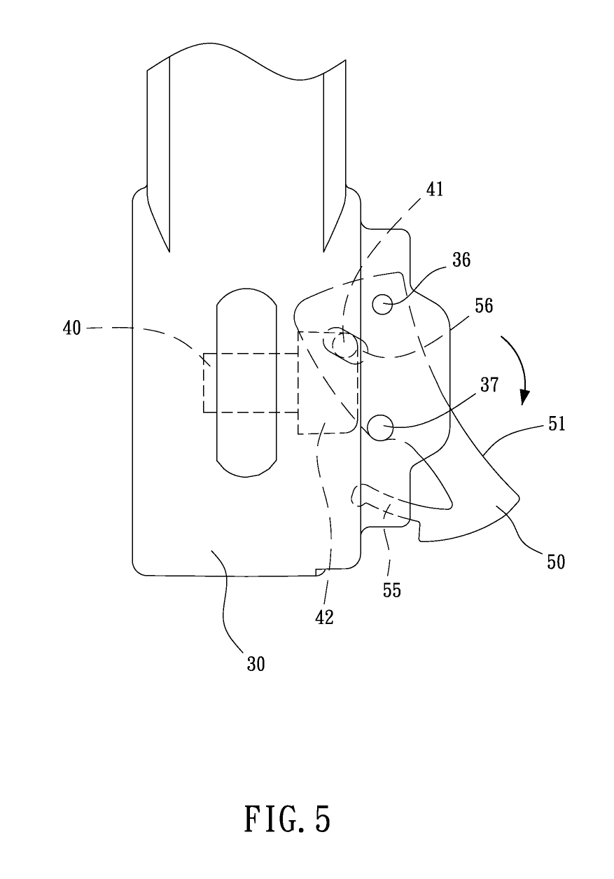

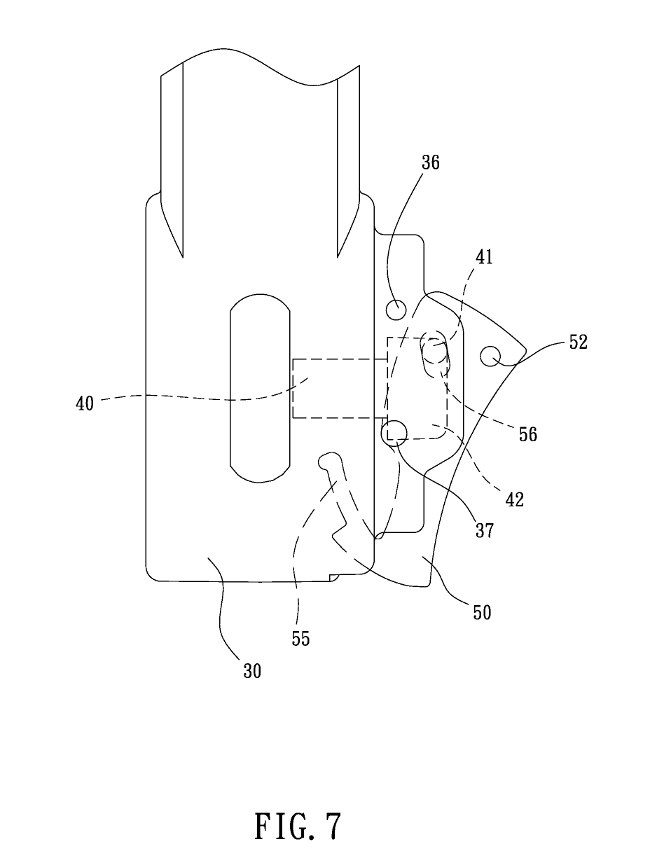

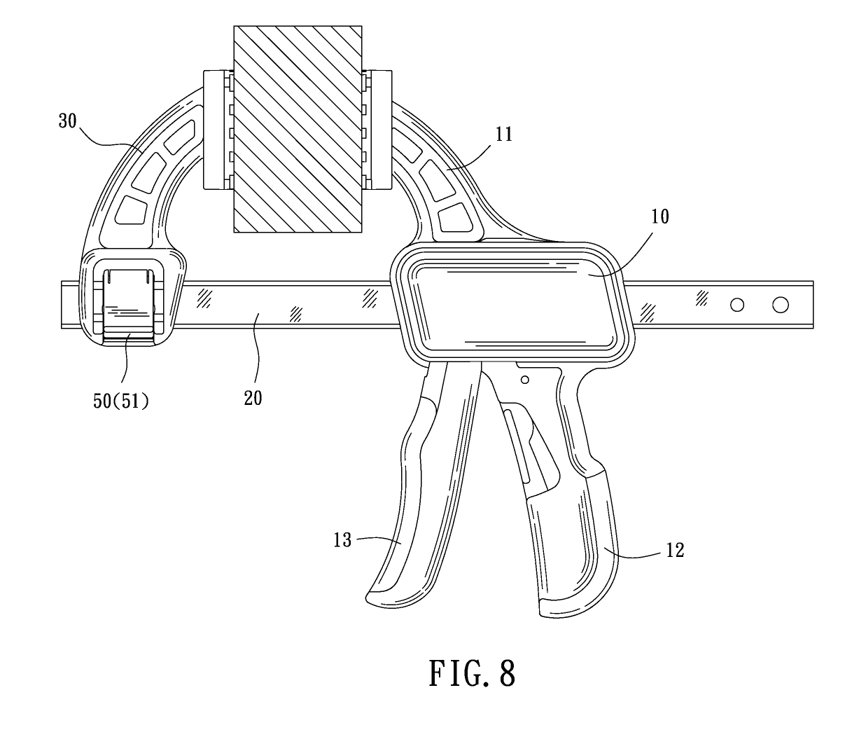

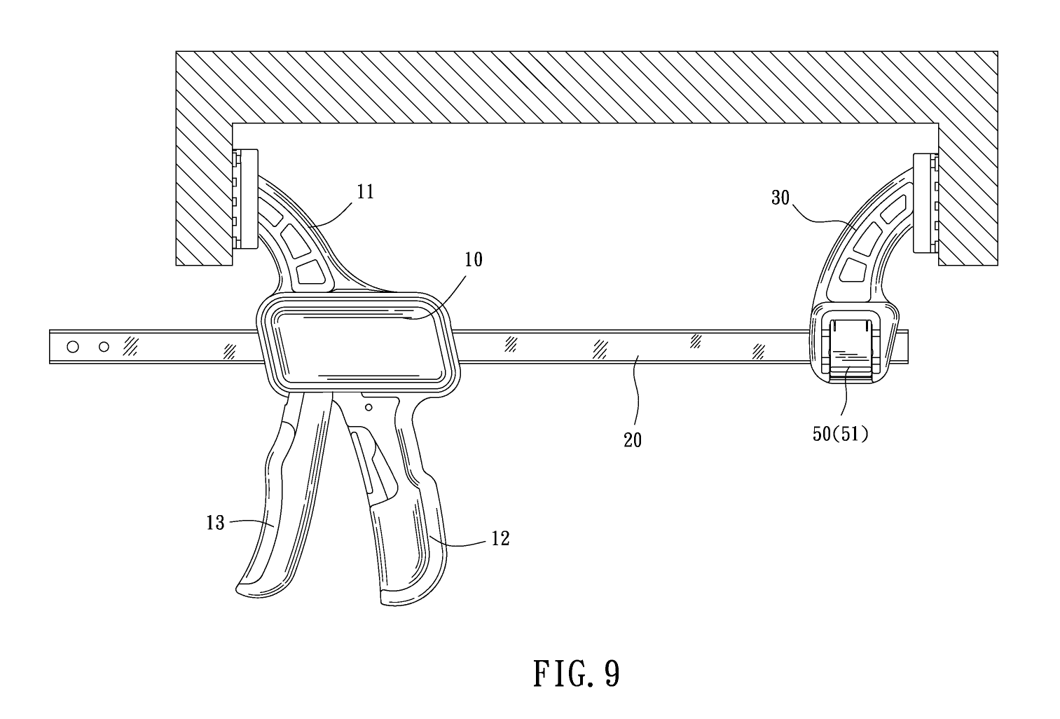

Please refer to FIGS. 3 to 7. When the user intends to change the manner of clamping an article with the movable chuck (11) and the fixed chuck (30), as shown in FIGS. 8 and 9, the user needs only to press the pressing portion (51) of the quick release element (50). As shown in FIGS. 4 and 5, when the fixed chuck (30) is fixed by the fixing rod (40), the elastic piece (55) of the quick release element (50) is inserted into the engaging trough (38) due to the pressing of the lower end of the pressing portion (51). In this way, the quick release element (50) swings by using the positioning shaft (53) as a center of rotation, so that the fixing rod (40) rotates accordingly because the two positioning portions (41) are pivotally disposed in the pivotal hole (56). As a result, the fixing rod (40) moves horizontally to remove from the fixing hole (21) of the transverse rod (20), thereby detaching the fixed chuck (30) as shown in FIGS. 3 and 7.

On the other hand, when the user intends to fix the fixed chuck (30), the user presses the upper end of the pressing portion (51) to cause the quick release element (50) to swing reversely. As a result, the elastic piece (55) removes from the engaging trough (38) to drive the fixing rod (40) to move inwardly and horizontally so as to pass through the fixing hole (21) of the transverse rod (20). In this way, the fixed chuck (30) is fixed on the transverse rod (20) and firmly engaged in the positioning holes (36) due to the two positioning protrusions (52).

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A quick release structure for a woodworking clamp, including a clamp body, a transverse rod and a fixing chuck, an upper edge of the clamp body being provided with a movable chuck, the clamp body being slidingly connected to one end of the transverse rod, the fixed chuck having a fixing rod disposed through a fixing hole of the transverse rod to thereby fix the fixed chuck to the other end of the transverse rod, characterized in that:
one end of the fixing rod is provided with two positioning portions, one side of the fixed chuck which the transverse rod is disposed through is formed with an accommodating portion, both sides of the accommodating portion are provided with a pivoting member for pivotally connecting to a quick release element, an outer surface of the quick release element is provided with a pressing portion, two opposite inner walls of the quick release element are formed with an elongate pivotal hole respectively for allowing the positioning portions of the fixing rod to be pivotally connected thereto;
whereby, the quick release element is pressed to drive the fixing rod to engage with or disengage from the fixing hole when the quick release element is pivotally connected into the accommodating portion of the fixed chuck, thereby detaching or assembling the fixed chuck.

2. The quick release structure of a woodworking clamp according to claim 1, wherein both sides of a upper portion of the accommodating portions is provided with a positioning hole respectively, a pivotal hole is formed below each positioning hole, both sides of an upper portion of the quick release element is formed with a positioning portion respectively, a positioning shaft is formed below each positioning protrusion, the two positioning shafts are disposed into the two shaft holes, and the two positioning protrusions are engaged within the positioning holes respectively, thereby achieving a pivotal connection of the quick release element.

3. The quick release structure of a woodworking clamp according to claim 2, wherein a slot having a length is provided on each side of the upper portion of the quick release element, so that both sides of the quick release element are able to be elastically pressed to facilitate the assembling of the positioning shafts into the pivotal holes.

4. The quick release structure of a woodworking clamp according to claim 1, wherein the positioning portion is integrally formed on one end of the fixing rod.

5. The quick release structure of a woodworking clamp according to claim 1, wherein a connecting block is connected to an outer surface of the positioning portion, both sides of the top end of the connecting block are provided with a positioning portion respectively, upper and lower surfaces of the connecting block are provided with a trough respectively, the interior of the fixed chuck are provided with two partitioning plates in the accommodating portion to correspond to the fixing hole inserted by the fixing rod, two facing surfaces of the partitioning plates are provided with a rib respectively, the rib is inserted into the corresponding trough when the connecting block is disposed on the partitioning plates.

6. The quick release structure of a woodworking clamp according to claim 1, wherein the lower edge of the quick release element facing the pivotal hole is provided with a curved elastic piece, the inner surface of the accommodating portion of the fixed chuck is provided with an engaging trough;
wherein the elastic piece is inserted into the engaging trough when the lower end of the pressing portion of the quick release element is pressed, so that the fixing rod moves horizontally to remove from the fixing hole of the transverse rod to thereby detach the fixed chuck; and
wherein the elastic piece is removed from the engaging trough when the upper end of the pressing portion of the quick release element is pressed, so that the fixing rod is caused to move inwardly and horizontally to pass through the fixing hole of the transverse rod to thereby fixing the fixed chuck to the transverse rod.
